(19) United States
(12) Patent Application Publication
(10) Pub. No.: US 2011/0017076 A1
(43) Pub. Date: Jan. 27, 2011

(54) SLIDING TOASTER

(75) Inventor: Atil KIZILBAYIR, Buyukcekmece (TR)

Correspondence Address: EGBERT LAW OFFICES, 412 MAIN STREET, 7TH FLOOR, HOUSTON, TX, 77002, US

(73) Assignee: ARZUM ELEKTRIKLI EV ALETLERI SANAYI VE TICARET ANONIM SIRKETI, Istanbul (TR)

(21) Appl. No.: 12/510,224

(22) Filed: Jul. 27, 2009

(51) Int. Cl. A47J 37/08

(52) U.S. Cl. 99/386

(57) ABSTRACT

The present invention is a sliding toaster. Slices of bread to be toasted are placed on the sliding plate out of the toaster body, and the sliding plate is slid into the toaster body by fitting into the channels in the toaster body. After the bread is toasted, sliding plate is taken from the toaster body by sliding it.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention shall be used for toasting bread, but it is totally different from the current toasters in terms of mechanism, composition and usage.

2. Description of Related Art Including Information Disclosed under 37 CFR 1.97 and 37 CFR 1.98

Known toasters work by means of putting the slices of bread in the toaster holes in a closed body and taking the toasted slices from the machine when these holes move upwards.

### BRIEF SUMMARY OF THE INVENTION

With the invention, prevention of burning the slices of bread put in the machine for toasting, ejection of slices of bread from the machine as a result of discharging from the machine after being toasted, cleaning the device completely and avoiding dirtying the environment are aimed.

### DESCRIPTION OF THE SHAPES

1) Body
2) Sliding plate
3) Metal base plate and grills
4) Sliding plate (side view)
5) Sliding plate (slices of bread put in the plate)
6) Sliding plate slid into the body
7) View of the control panel on the body
8) Putting the sliding plate with slices of bread on

### PARTS NUMBERS

1. Toaster body
2. Graded temperature system
3. Control panel
4. Sliding plate
5. Channel
6. Metal base plate
7. Grill

### BRIEF DESCRIPTION OF THE SEVERAL VIEWS OF THE DRAWINGS

FIG. 1 is a simplified perspective view of the toaster body of the present invention.

FIG. 2 is a simplified perspective view of the sliding plate of the present invention.

FIG. 3 is a partial perspective view of the metal base plate and grills of the present invention.

FIG. 4 is a perspective view of the sliding plate of the present invention.

FIG. 5 is another perspective view of the sliding plate of the present invention.

FIG. 6 is still another perspective view of the present invention.

FIG. 7 is another perspective view of the present invention.

FIG. 8 is a perspective view of the present invention.

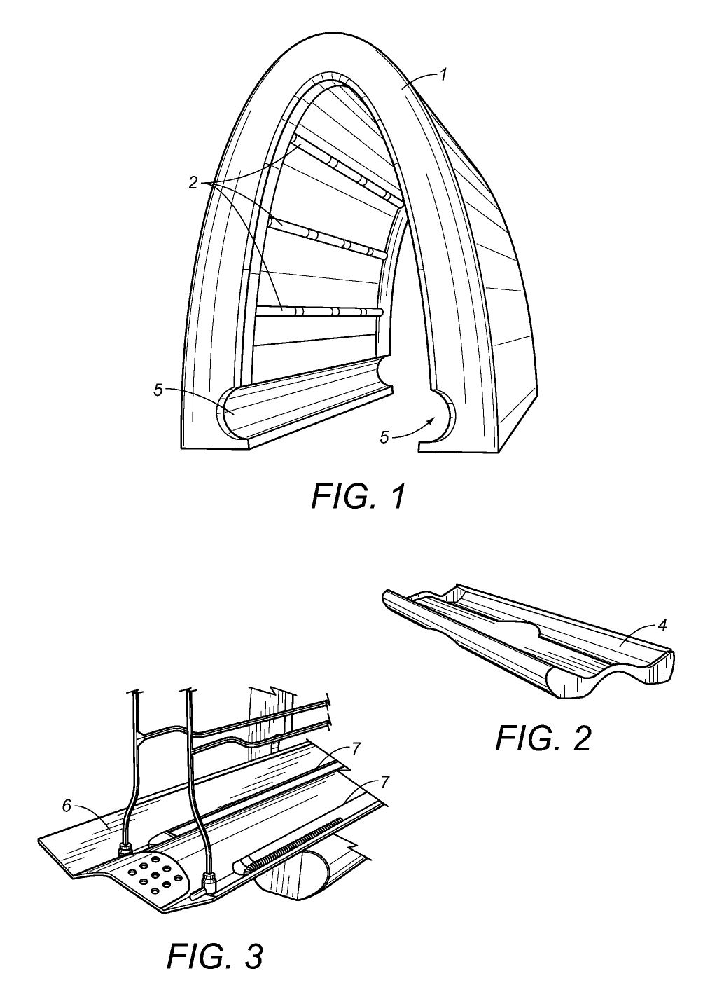

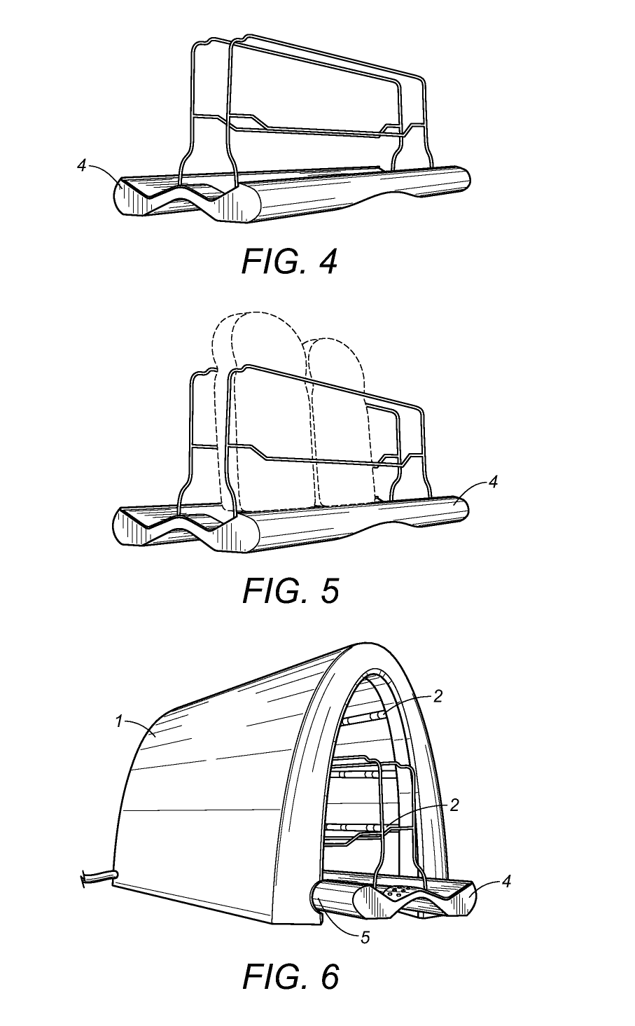

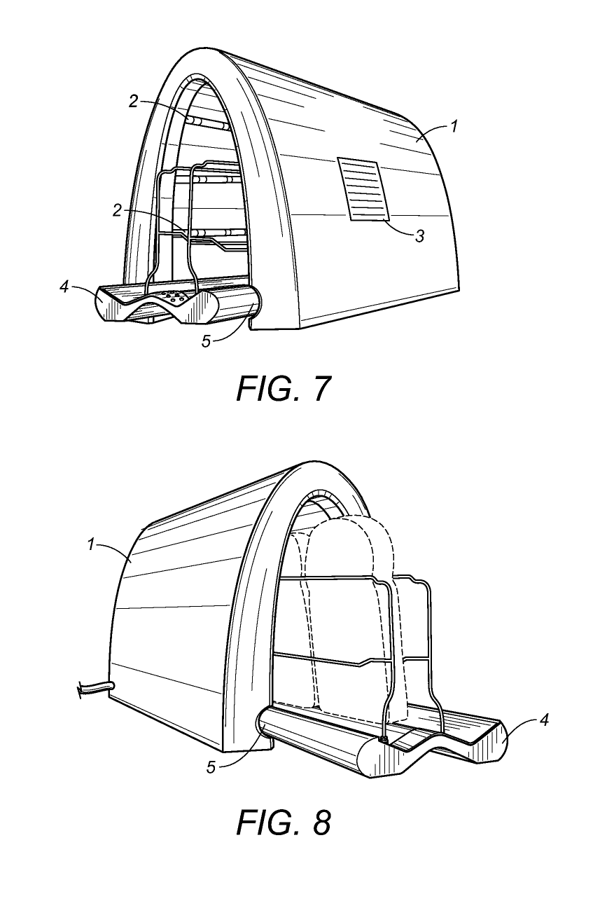

### DETAILED DESCRIPTION OF THE INVENTION

The invention consists of a toaster body (1), graded temperature system (2), control panel (3), sliding plate (4), channel (5), metal base plate (6) and grill (7).

The toaster body (1) has a graded temperature system (2) that toasts bread in different toasting temperatures which will enable to toast the slices of bread in the desired level.

Also, a control panel (3) with a screen that shows grades, temperature adjustment, starting buttons, remaining time, used thermo units and degree which commands the graded temperature system (2) is found outside the toaster body (1).

Two channels (5) facing each other are found in the toaster body (1) to enable the sliding plate (4) slide into the body.

Sliding plate (4) is designed in a way to be slid into and pulled out again from the toaster body (1) easily by fitting into the channel (5).

The metal base plate (6) fits on top of the sliding plate (4) and has grills (7) for the bread crumbs to fall down on the sliding plate (4)

### APPLICATION METHOD OF THE INVENTION

Slices of bread to be toasted are placed on the sliding plate (4) out of the toaster body (1) and sliding plate is slid into the toaster body (1) by fitting into the channels (5) in the toaster body.

Graded temperature adjustment of the heater which is suitable for toasting bread in different toasting levels from the control panel (3) is made in the desired way and graded temperature system (2) is operated. Used thermo units, degree and remaining time are followed on the screen.

After the bread is toasted, sliding plate (4) is taken from the toaster body (1) by sliding it without facing the problems such as burning of the hand during taking the toasted bread from the usual toasters, and problems arising from ejection mechanisms.

No residue or pieces stay in the environment after the toasting process. Cleaning is made extremely easily and the desired hygiene is ensured because unnecessary mechanical accessories, panel and wire surfaces that get dirty in the standard toasters are not found in it. Crumbs go to the below plate from the grills (7) found in the metal base plate (6). Metal base plate (6) is removed and crumbs on the base are cleaned.

In this way, there is no interference by hand or any other thing as in the current toasters, and bread jamming in the body is out of the question because bread to be toasted and toasted bread are put on or taken from the sliding plate (4) totally out of the toaster body (1). This situation plays an essential role in cleaning the machine and ensures hygiene in addition to prevention of accidents and difficulties faced in the current machines.

1. A toaster comprising:
a toaster body,
graded temperature system,
control panel,
sliding plate,
channel,
metal base plate, and
grill.

2. The toaster, according to claim 1, wherein said toaster body has channels being removably slidable with said sliding plate, after toasting.

3. The toaster, according to claim 1, wherein said toaster body has said graded temperature system and said control panel housed therein.

4. The toaster, according to claim 1, wherein said toaster body has a metal base plate, said grills being mounted on said metal base plate.
